(19) United States
(12) Patent Application Publication
(10) Pub. No.: US 2017/0305265 A1
(43) Pub. Date: Oct. 26, 2017

(54) COMPONENT MOUNTING STRUCTURE FOR FUEL TANK

(71) Applicant: Yachiyo Industry Co., Ltd., Sayama-shi, Saitama (JP)

(72) Inventors: Kazuaki Shoji, Sakura-shi, Tochigi (JP); Kazuhiro Nakamura, Sayama-shi, Saitama (JP)

(73) Assignee: Yachiyo Industry Co., Ltd., Sayama-shi, Saitama (JP)

(21) Appl. No.: 15/529,784

(22) PCT Filed: Sep. 16, 2015
(86) PCT No.: PCT/JP2015/004740

§ 371 Date: May 25, 2017

(30) Foreign Application Priority Data
Nov. 27, 2014 (JP) 2014-240490

(51) Int. Cl. B60K 15/03

(52) U.S. Cl. CPC B60K 15/03; B60K 2015/03447; B60K 2015/03453

(57) ABSTRACT

To provide a component mounting structure for a fuel tank capable of suppressing an increase in the weight of the tank body and reducing the weight and thickness of the fuel tank component, the component mounting structure includes: a tank body (2) provided with an oblong opening (2a); a pump module (3) serving as a tank component mounted to the tank body (2); a flange (5) that is provided to the pump module (3) so as to project out from an outer surface of the pump module (3), has an oblong contour larger than the opening (2a) and having a minor dimension (W2) smaller than a major dimension (L1) of the opening (2a), and is placed inside the tank body (2) through the opening (2a) with an edge thereof opposing the tank body (2) over an entire circumference; a sealing member (7) placed between the tank body (2) and the flange (5); and a fastening member (8b•9, 11•12) that holds the pump module (3) to the tank body (2) while compressing the sealing member (7) via the flange (5).

### TECHNICAL FIELD

The present invention relates to a component mounting structure for a fuel tank for mounting a tank component to a tank body, wherein at least a part of the tank component is inserted into an interior of the tank body through an opening formed in the tank body.

### BACKGROUND ART

Fuel tanks for automobiles or the like may be equipped with components, such as a fuel pump, mounted to the tank body. In recent years, an increasing number of fuel tanks are being made of resin. As a structure for mounting a component to a fuel tank made of resin, there is a structure in which the component part is integrally mounted to the tank body at the time of molding the tank body, and in another structure, the tank body is provided with a mounting part having an opening and the component is mounted to the mounting part. Of these structures, the structure in which the component part is mounted to the mounting part typically includes a sealing structure in which a sealing member is provided between the mounting part and the component to prevent the fuel gas from leaking through the opening, and the tank component is secured such that the sealing member is compressed.

As the component mounting structure including such a sealing structure, there is known a structure in which the part of the tank body where the opening is defined is provided with a tubular part protruding in the outward direction of the tank and a male screw thread is formed on the outer circumference of the tubular part, wherein a flange of the tank component and the sealing member are sandwiched and fastened betweenthe tubular part and a union nut provided with a female screw thread that can threadably engage the male screw thread (see Patent Document 1, for example). Also, a technique is known in which, instead of forming a screw thread, a securing bracket made of steel is insert molded in the tank body and another bracket is used to fix (camlock) the flange of the tank component such that an O-ring is compressed.

### PRIOR ART DOCUMENT(S)

### Patent Document(s)

[Patent Document 1] JP2005-41331A

### BRIEF SUMMARY OF THE INVENTION

### Task to be Accomplished by the Invention

However, in a case where the tank body is formed by blow molding, for example, the conventional screw-type structure requires the tubular part to have a prescribed height to secure a length of thread engagement. Therefore, to prevent reduction of wall thickness at the top, it is necessary to increase the wall thickness of the tank body around the screw thread over the entire circumference of the parison, and this leads to an increase in the weight of the tank body. Also, if the tubular part has a large protruding height for the formation of the screw thread, a degree of design freedom is reduced. To reduce the protruding height of the tubular part, it is possible to recess a part of the wall around the tubular part by an amount corresponding to the height of the tubular part, but this would decrease the capacity of the tank. Further, to ensure reliability of the seal, the number of parameters need to be controlled during manufacture, such as sizes and fastening force, is increased.

On the other hand, the camlock type has an advantage that assembly can be achieved easily with one-touch operation and there are a few control parameters, but because the camlock fitting is made of steel, an overall weight is increased. Further, because the camlock fitting and the tank body are made of different materials, anti-shock measures are necessary, and in addition, a difference in the coefficient of linear expansion between the materials affects the reliability of the seal.

The present invention has been made in view of such background, and a main object of the present invention is to provide a component mounting structure for a fuel tank capable of suppressing an increase in the weight of the tank body and reducing the weight and thickness of the fuel tank component.

### Means to Accomplish the Task

To achieve the above object, the present invention provides a component mounting structure for a fuel tank (1), comprising: a tank body (2) provided with an oblong opening (2a); a tank component (3) mounted to the tank body; a flange (5) that is provided to the tank component so as to project out from an outer surface of the tank component, has an oblong contour larger than the opening and having a minor dimension (W2) smaller than a major dimension (L1) of the opening, and is placed inside the tank body through the opening with an edge thereof opposing the tank body over an entire circumference; a sealing member (7) placed between the tank body and the flange; and a fastening member (8b•9, 11•12) that holds the tank component to the tank body while compressing the sealing member via the flange.

It is to be noted here that the major dimension and the minor dimension in this description are not used with an intension to limit the contour of the opening and the flange is elliptic, but are used to indicate the largest width dimension and the smallest width dimension of the oblong part, respectively. Namely, “oblong” includes oval shape, rectangular shape, etc. in addition to elliptic shape.

According to this configuration, because it is not necessary to form a screw thread on the tank body to mount the tank component to the tank body, it is possible to avoid an increase in the wall thickness of the tank body and suppress an increase in the weight of the tank body. Further, because a component mounting structure having a sealing ability can be achieved by simply providing the tank component constituting the fuel tank with a flange and by providing a fastening member that holds the tank component to the tank body while compressing the sealing member, the weight and thickness of the fuel tank component can be reduced.

Also, in the above configuration, the fastening member may be configured to comprise: an overhanging wall (8b) provided to the tank component to project out from the outer surface of the tank component (3) at a position displaced from the flange (5) in an outward direction of the tank such that the overhanging wall is placed outside the tank body when the tank component has been mounted to the tank body (2); and a pair of semi-annular members (9a, 9a) press-fitted between the tank body and the overhanging wall to compress the sealing member (7).

According to this configuration, fastening member can be realized by a simple structure of the pair of semi-annular members press-fitted between the tank body and the overhanging wall placed outside the tank body. Further, because the overhanging wall and the semi-annular members do not have to be made of steel or have a large wall thickness, it is possible to reduce the weight and thickness of these parts and reduce the protruding height from the tank body.

Further, in the above configuration, the semi-annular members (9a) may be each configured to have protrusions (9b) or recesses engaging the tank body (2) and the overhanging wall (8b).

According to this configuration, it is possible to prevent relative movement between the tank body and the semi-annular members and relative movement between the semi-annular members and the overhanging wall.

Also, in the above configuration, the fastening member may be configured to comprise: a screw thread (11) formed on the tank component (3) so as to be placed at a position outside the tank body or opposing the opening (2a) when the tank component has been mounted to the tank body (2); and a screw member (12) that threadably engages the screw thread to cause a reaction force to act upon an outer surface of the tank body to compress the sealing member (7).

According to this configuration, the screw member can cause the tank component to compress the sealing member without fail.

### Effect of the Invention

Thus, according to the present invention, a component mounting structure for a fuel tank capable of suppressing an increase in the weight of the tank body and reducing the weight and thickness of the fuel tank component can be provided.

### BRIEF DESCRIPTION OF THE DRAWINGS

FIG. 1 is a cross-sectional view of a fuel tank according to the first embodiment;

FIG. 2 is an enlarged cross-sectional view showing a part II in FIG. 1;

FIG. 3 is a perspective view showing a support member and a press-fit member shown in FIG. 2, as viewed from the bottom;

FIG. 4A is a schematic diagram showing a pump module in a mounted state, and FIG. 4B is a schematic diagram showing the relationship between a flange and an opening during mounting of the pump module; and

FIG. 5 is a cross-sectional view of an essential part of a fuel tank according to the second embodiment.

### EMBODIMENTS FOR CARRYING OUT THE INVENTION

In the following, embodiments of the present invention will be described in detail with reference to the drawings.

### First Embodiment

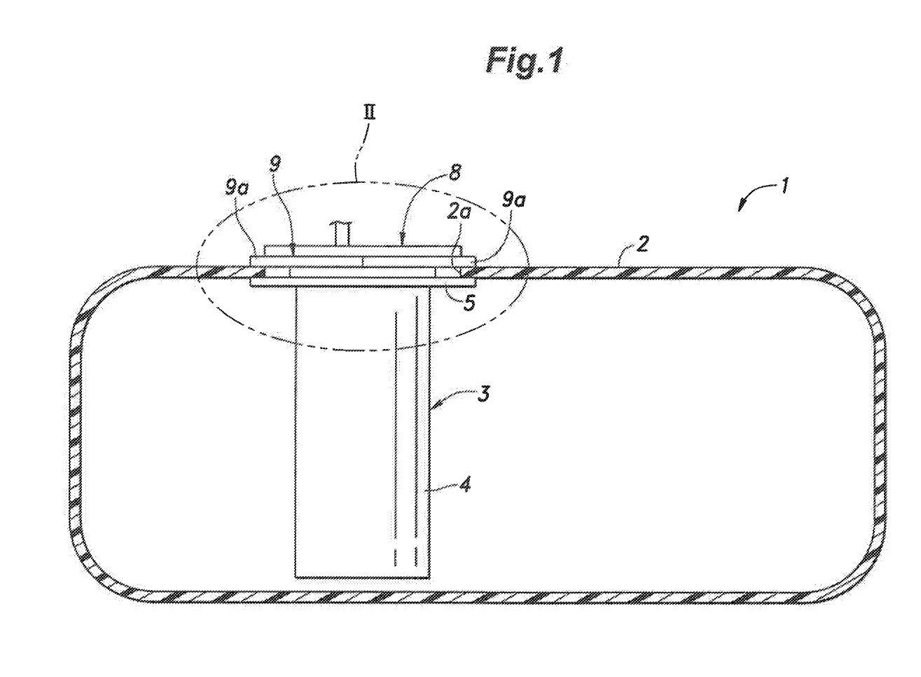

First, with reference to FIGS. 1 to 4, a first embodiment of the present invention will be described. As shown in FIG. 1, a fuel tank 1 includes a resin tank body 2 having an annular side wall, an upper wall, and a bottom wall and exhibiting a substantially rectangular parallelepiped shape with rounded corners. The upper all of the tank body 2 is provided with an opening 2a, and a pump module 3, which is a tank component, is mounted to the tank body 2 by being inserted in the opening 2a.

The tank body 2 is a fuel storage container having a multi-layer structure, which is manufactured by setting two resin sheets formed by melt extrusion between upper and lower molds and conducting vacuum forming, for example. The opening 2a is formed by cutting out a part of the upper wall after the tank body 2 has been formed as a closed container.

The pump module 3 is an assembly of a fuel pump (not shown in the drawings) for pumping the fuel stored in the tank body 2 to outside and other devices such as a fuel filter integrally housed in a resin casing. The pump module 3 is mounted to the tank body 2, with the entirety thereof being inserted in the interior of the tank body 2 through the opening 2a. The pump module 3 has a cylindrical case body 4 and a flange 5 formed integrally in an upper part of the case body 4 to project out radially from an outer surface of the case body 4. The flange 5 is formed to be larger than the opening 2a and, in the mounted state, is placed inside the tank body 2 and in pressed contact with a lower surface of the tank body 2 over the entire circumference of the edge.

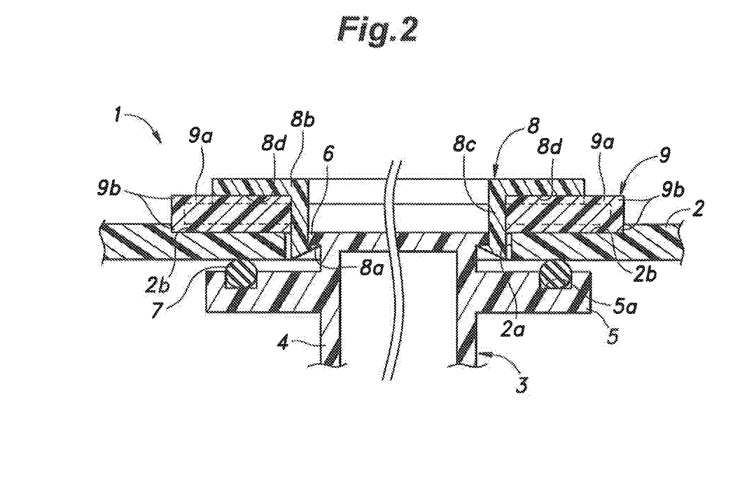

As also shown in FIG. 2, a part of the case body 4 above the flange 5 is integrally provided with an overhanging projection 6 that projects radially outward from the outer surface. The overhanging projection 6 may be formed to extend over the entire circumference of the case body 4, or may include a plurality of parts that are spaced apart in the circumferential direction. In the present embodiment, the overhanging projection 6 is formed in a disk shape projecting out by a constant amount over the entire circumference of the case body 4.

An annular groove 5a is formed in the upper surface of the flange 5, and an O-ring 7 serving as a sealing member is fitted in the annular groove 5a so as to protrude from the upper surface of the flange 5. Namely, the O-ring 7 is placed between the tank body 2 and the flange 5, and the flange 5 is in pressed contact with the lower surface of the tank body 2 via the O-ring 7. As the flange 5 causes the O-ring 7 to engage the lower surface of the tank body 2, the pump module 3 is mounted to the tank body 2 air-tightly. The flange 5 itself may or may not be in contact with the tank body 2.

The pump module 3 is mounted to the tank body 2 such that the flange 5 is pressed against the lower surface of the tank body 2 owing to a support member 8 having a claw 8a engaging the lower surface of the overhanging projection 6 and a press-fit member 9 disposed between the support member 8 and the tank body 2. Namely, the press-fit member 9 cooperates with the support member 8 to compress the O-ring 7 via the flange 5, and in this state, constitutes a fastening member that holds the pump module 3 to the tank body 2.

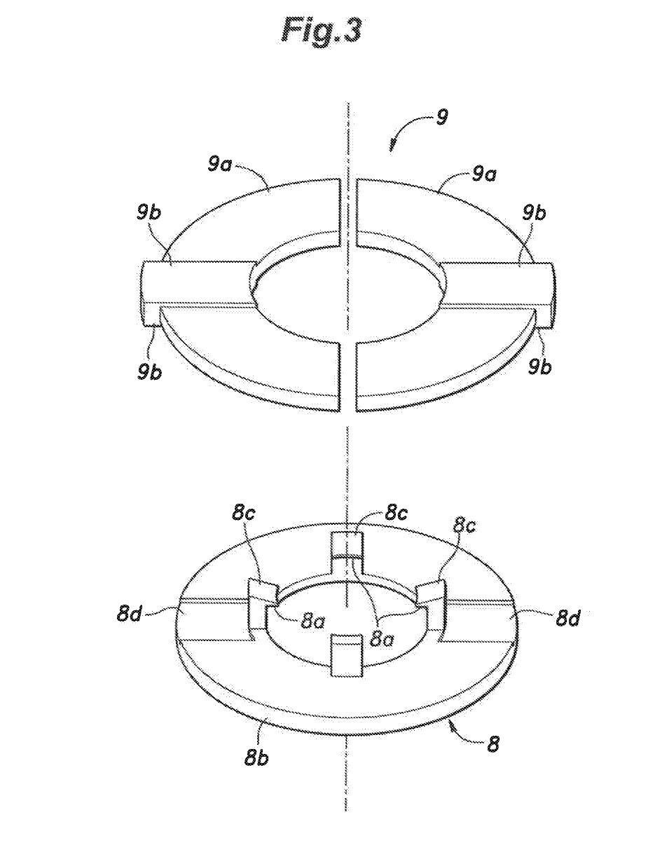

FIG. 3 is an exploded perspective view showing the support member 8 and the press-fit member 9 turned upside down. As shown in FIGS. 2 and 3, the support member 8 includes a disk part 8b (overhanging wall) provided at a position displaced from the flange 5 in the outward direction of the tank body 2 and projecting out from the outer surface of the case body 4 to have a contour larger than that of the case body 4 as seen in plan view, and a plurality of extending parts 8c extending downward from the disk part 8b and each having the claw 8a at its tip end. In the illustrated embodiment, the disk part 8b consists of an annular plate, and the extending parts 8c are formed on an inner edge of the disk part 8b at four positions equally spaced from each other. The contour of the disk part 8b is made to be larger than the opening 2a of the tank body 2, while the inner circumferential edge of the disk part 8b is smaller than the opening 2a of the tank body 2 such that the all four extending parts 8c can be inserted in the opening 2a. The length of the extending parts 8c is determined such that in a state where the claws 8a engage the overhanging projection 6, the disk part 8b is placed outside the tank body 2 and a gap is created between the tank body 2 and the disk part 8b.

The press-fit member 9 is press-fitted between the tank body 2 and the disk part 8b of the support member 8 and thereby pushes the support member 8 upward to bring the flange 5 of the pump module 3 into pressed contact with the lower surface of the tank body 2. The press-fit member 9 is constituted of a pair of semi-annular members 9a, 9a which form an annular plate when attached to the tank body 2. In this embodiment, the semi-annular members 9a, 9a are formed in a flat plate shape but may be formed in a tapered shape to become thinner toward the inner side.

The upper and lower surfaces of each of the semi-annular members 9a, 9a are each provided with a protrusion 9b. On the other hand, at positions of the disk part 8b of the support member 8 and the tank body 2 corresponding to the protrusions 9b are formed recesses 8d, 2b for receiving the corresponding protrusions 9b. The engagement of the protrusions 9b of the semi-annular members 9a with the recesses 8d of the support member 8 and the recesses 2b of the tank body 2 prevents relative movements including the relative rotation between the support member 8 and the tank body 2. Also, though not shown in the drawings, the lower surface the overhanging projection 6 of the pump module 3 is provided with a stopper that projects to prevent movement of the claws 8a of the support member 8, whereby the relative rotation between the support member 8 and the pump module 3 also is prevented.

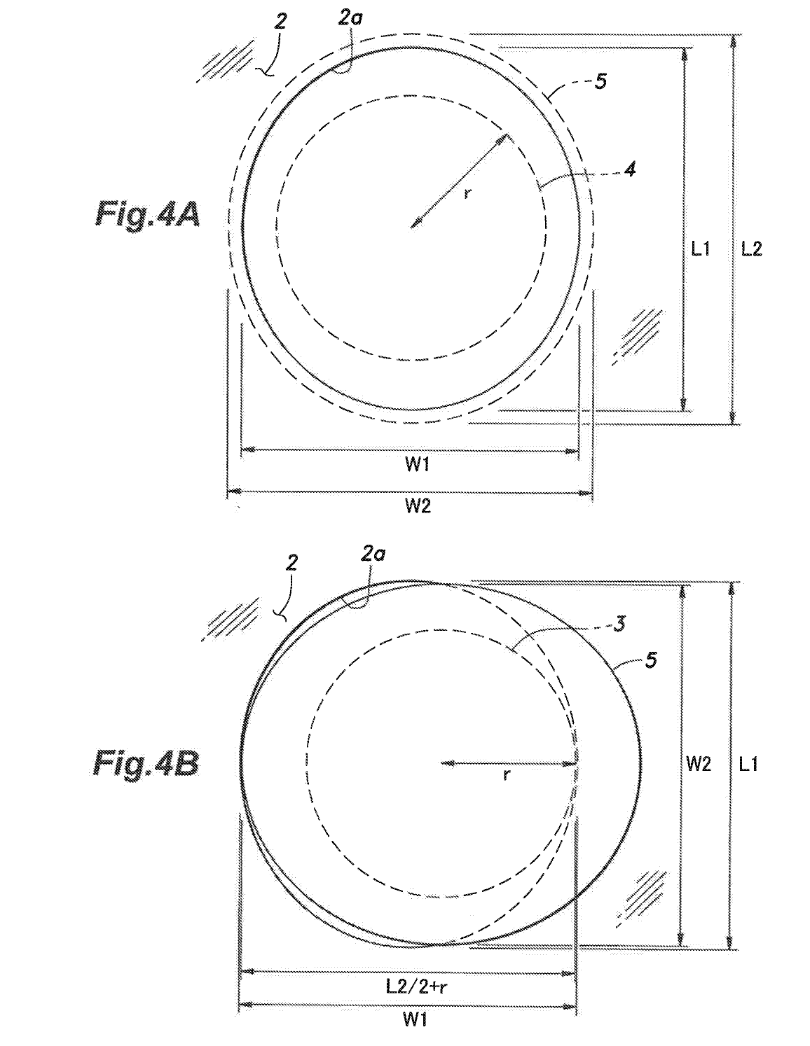

Next, with reference to FIG. 4, description will be made of the shapes and dimensions of the opening 2a of the tank body 2 as well as the case body 4 and the flange 5 of the pump module 3. FIG. 4A shows a state where the pump module 3 is mounted to the tank body 2, and FIG. 4B shows a state during a process of mounting the pump module 3 to the tank body 2 (a stage at which the flange 5 is inserted into the tank body 2).

As shown in FIG. 4A, the opening 2a of the tank body 2 and the flange 5 each have an oblong contour. The case body 4 may be in any shape. In this embodiment, for the sake of convenience, description will be made assuming that the opening 2a of the tank body 2 and the flange 5 each have an elliptical shape, and that the case body 4 has a circular shape and is positioned at the center of the flange 5 (the center is on the focus). The opening 2a has a major dimension L1 and a minor dimension W1. The flange 5 has a major dimension L2 larger than L1 (L2>L1) and a minor dimension W2 larger than W1 (W2>W1). The case body 4 has a radius r smaller than a half of W1 (r<W/2). Therefore, the case body 4 can be inserted in the opening 2a, and the flange 5 can close the opening 2a. Further, these dimensions satisfy the following relationships:

W2<L1 (1)

W1>L2/2+r (2)

Therefore, as shown in FIG. 4B, by positioning the pimp module 3 such that the minor axis of the flange 5 is in parallel with the major axis of the opening 2a and, with the case body 4 having been inserted in the opening 2a, moving the pump module 3 toward one side in the minor axis direction of the opening 2a (right side in the drawing), one end of the flange 5 in the major axis direction thereof can be inserted in the opening 2a. After inserting the one end of the flange 5 in the major axis direction thereof in the opening 2a, by moving the pump module 3, which is slightly tilted, toward the opposite side in the minor axis direction of the opening 2a (left side in the drawing), the opposite end of the flange 5 in the major axis direction thereof can be inserted in the opening 2a. After placing the entirety of the flange 5 inside the tank body 2, by rotating the pump module 3 by 90 degrees, it is possible to put the pump module 3 in the state shown in FIG. 4A, with the edge of the flange 5 in pressed contact with the tank body 2 over the entire circumference thereof.

After placing at least the flange 5 of the pump module 3 in the interior of the tank body 2 as described above, by having the support member 8 engage the pump module 3 and press-fitting the press-fit member 9 between the disk part 8b of the support member 8, which is placed outside the tank body 2, and the tank body 2 as shown FIG. 2, it is possible to bring the flange 5 of the pump module 3 into pressed contact with the inner surface of the tank body 2 and compress the O-ring 7 via the flange 5.

The mounting structure configured as described above can provide the following effects. As shown in FIGS. 1 to 3, because the tank body 2 is provided with the oblong opening 2a, and the flange 5 of the pump module 3 has an oblong contour larger than the opening 2a and having a minor dimension smaller than the major dimension of the opening 2a, it is possible to place the flange 5 in the interior of the tank body 2 through the opening 2a and to make the edge of the flange 5 oppose the tank body 2 over the entire circumference thereof. Further, because the O-ring 7 is placed between the tank body 2 and the flange 5, and the pair of semi-annular members 9a and the disk part 8b of the support member 8, which serve as a fastening member, cooperate with each other to compress the O-ring 7 via the flange 5 and to hold the pump module 3 to the tank body 2 in this state, the sealing between the tank body 2 and the pump module 3 is ensured.

Also, it is unnecessary to form a screw thread on the tank body 2 to mount the pump module 3 to the tank body 2, and therefore, it is possible to avoid an increase in the wall thickness of the tank body 2 and suppress an increase in the weight of the tank body 2. In addition, a component mounting structure having a sealing ability can be realized by simply providing the flange 5 to the pump module 3 constituting the fuel tank 1 and providing the pair of semi-annular members 9a and the disk part 8b of the support member 8 to hold the pump module 3 to the tank body 2 while compressing the O-ring 7, and therefore, it is possible to reduce the weight and thickness of the support member 8 and the semi-annular members 9a constituting the fuel tank 1.

In this embodiment, the disk part 8b of the support member 8 engaging the pump module 3 is provided to project out from the outer surface of the pump module 3 at a position displaced from the flange 5 of the pump module 3 in the outward direction of the tank, and is placed outside the tank body 2 when the pump module 3 has been mounted to the tank body 2. Therefore, it is possible to compress the O-ring 7 with a simple configuration and process of press-fitting the semi-annular members 9a between the tank body 2 and the disk part 8b. Further, because there is no need to make the disk part 8b and the semi-annular members 9a of steel and/or to make them have a large wall thickness, the weight and thickness of these members can be reduced and the height of these members protruding from the tank body 2 can also be reduced.

In addition, in this embodiment, the semi-annular members 9a have the protrusions 9b engaging the recesses 2b, 8d formed on the tank body 2 and the disk part 8b of the support member 8, and this prevents the relative movement between the tank body 2 and the semi-annular members 9a and the relative movement between the semi-annular members 9a and the disk part 8b.

### Second Embodiment

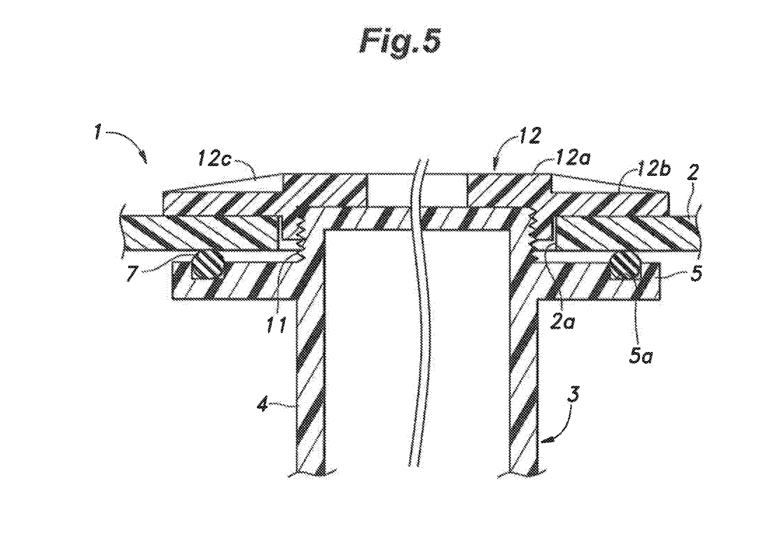

Next, with reference to FIG. 5, a second embodiment of the present invention will be described. The members and parts similar to those of the first embodiment will be denoted by same reference signs and redundant description will be avoided.

As shown in FIG. 5, in this embodiment, a male screw thread 11 is formed in the upper end portion of the case body 4 of the pump module 3, and a flange nut 12 threadably engaging this male screw thread 11 puts the flange 5 of the pump module 3 in pressed contact with the inner surface of the tank body 2 and compresses the O-ring 7 via the flange 5. In this embodiment, the male screw thread 11 is formed to extend to the outside of the tank body 2 in the mounted state. However, the male screw thread 11 may be placed inside the tank body 2 in the mounted state if the male screw thread 11 is formed at a position opposing the opening 2a.

The flange nut 12 is provided with a nut part 12a threadably engaging the male screw thread 11 of the case body 4, a flange part 12b integrally formed on the outer circumferential surface of the nut part 12a, and ribs 12c formed on the side of the flange part 12b facing in the outward direction of the tank to connect the nut part 12a and the flange part 12b with each other. In this embodiment, the nut part 12a is formed to be smaller than the opening 2a, whereby the nut part 12a can be inserted in the opening 2a. The flange part 12b is formed to be larger than the opening 2a. The flange nut 12 causes a reaction force to act upon the outer surface of the tank body 2 to compress the O-ring 7.

As described above, because the pump module 3 is provided with the male screw thread 11 that is placed at a position outside the tank body 2 or opposing the opening 2a when the pump module 3 has been mounted to the tank body 2, and the flange nut 12 engages the male screw thread 11 to cause a reaction force to act upon the outer surface of the tank body 2 to thereby compress the O-ring 7, it is possible to compress the O-ring 7 with a simple structure. Further, because there is no need to make the flange nut 12 of steel and/or to make the flange nut 12 have a thick wall, the weight and thickness of the fuel tank 1 can be reduced and the height of the flange nut 12 protruding from the tank body 2 can also be reduced.

The concrete embodiments have been described in the foregoing, but the present invention is not limited to the above embodiments and various modifications and alterations may be made as appropriate within the sprit of the present invention. For example, in the above-described first embodiment, the support member 8 was constituted of a member separate from the pump module 3, but the support member 8 may be integrally provided to the pump module 3. Further, in the above embodiments, the pump module 3 was taken as an example of the tank component, but the tank component is not limited thereto, and various components may serve as the tank component. Similarly, in the above embodiments, the O-ring 7 was taken as an example of the sealing member, but the sealing member is not limited to the O-ring 7 and may be embodied by various members so long as they provide a sealing function. Further, in the above-described second embodiment, the pump module 3 was provided with the male screw thread 11 and the flange nut 12 was used as a screw member, but other embodiments, such as an embodiment in which the nut part 12a and the flange part 12b are separate members or an embodiment in which a female screw thread is formed on the pump module 3 at a position opposing the opening 2a and a flange bolt is used as the screw member, may also be possible. Besides, the concrete structure, number, material, mounting process, etc. of the structural elements of the present invention shown in the above embodiments may be changed as appropriate. Further, it is also possible to combine the structures shown in the above embodiments or to selectively adopt a part of the structural elements of the present invention shown in the above embodiments.

### GLOSSARY

1 fuel tank

2 tank body

2a opening

2b recess

3 pump module (tank component)

4 case body

5 flange

7 O-ring (sealing member)

8 support member

8b disk part (fastening member, overhanging wall)

8d recess

9 press-fit member (fastening member)

9a semi-annular members (fastening member)

9b protrusion

11 male screw thread (fastening member)

12 flange nut (fastening member, screw member)

L1 major dimension of opening 2a

W2 minor dimension of flange 5

1. A component mounting structure for a fuel tank, comprising:
a tank body provided with an oblong opening;
a tank component mounted to the tank body;
a flange that is provided to the tank component so as to project out from an outer surface of the tank component, has an oblong contour larger than the opening and having a minor dimension smaller than a major dimension of the opening, and is configured to be capable of being inserted in the opening, so that the flange is placed inside the tank body with an edge thereof opposing the tank body over an entire circumference;
a sealing member placed between the tank body and the flange; and
a fastening member that holds the tank component to the tank body while compressing the sealing member via the flange.

2. The component mounting structure according to claim 1, wherein the fastening member comprises:
an overhanging wall provided to the tank component to project out from the outer surface of the tank component at a position displaced from the flange in an outward direction of the tank such that the overhanging wall is placed outside the tank body when the tank component has been mounted to the tank body; and
a pair of semi-annular members press-fitted between the tank body and the overhanging wall to compress the sealing member.

3. The component mounting structure according to claim 2, wherein the semi-annular members each has protrusions or recesses engaging the tank body and the overhanging wall.

4. The component mounting structure according to claim 1, wherein the fastening member comprises:
a screw thread formed on the tank component so as to be placed at a position outside the tank body or opposing the opening when the tank component has been mounted to the tank body; and
a screw member that threadably engages the screw thread to cause a reaction force to act upon an outer surface of the tank body to compress the sealing member.

5. The component mounting structure according to claim 1, wherein the fastening member comprises:
an overhanging wall provided to the tank component to project out from the outer surface of the tank component at a position displaced from the flange in an outward direction of the tank such that the overhanging wall is placed outside the tank body when the tank component has been mounted to the tank body; and
a press-fit member press-fitted between the tank body and the overhanging wall to compress the sealing member.
